(19) United States
(12) Patent Application Publication
(10) Pub. No.: US 2006/0015589 A1
(43) Pub. Date: Jan. 19, 2006

(54) Generating a service configuration

(76) Inventors: Boon Seong Ang, Sunnyvale, CA (US); Michael Schlansker, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/892,338

(22) Filed: Jul. 16, 2004

(51) Int. Cl. G06F 15/177

(52) U.S. Cl. 709/220

(57) ABSTRACT

A service configuration for a service is generated using a service specification and at least one library including at least one of a hardware component and a software component available to be implemented for the service.

### BACKGROUND

Highly scalable computer systems of the future will be based on large ensembles of commodity components, such as processors, disk drives, memory, etc. As increasingly inexpensive, high-performance systems scale to even larger sizes, the tasks of deploying and managing hardware and software components and maintaining reliable and efficient computation with those components becomes increasingly complex and costly.

Designing, configuring and deploying hardware and software components of the large-scale systems to meet the requirements of different services typically involves a manual, labor-intensive process performed by information technology, systems hardware and/or software experts. Conventionally, the experts choose the hardware platform(s) and the different pieces of software applications that work together to provide a service. A service usually includes a hardware platform and an ensemble of programs providing the functionality of the service. Individual programs in the service may be connected to appropriate input data sets, output data sets, and temporary data sets and I/O devices. Often, the output of one application in the service serves as an input to another application in the service. After selecting the software and the hardware that work together to provide the service, the experts have to instantiate many parameters for each application, which for some complex business software run into hundreds of parameters. Proper selection of some parameters are necessary in order for the overall service to function at all, while choice of other parameters effects other important issues such as performance, security, and availability.

This conventional approach to designing, configuring and deploying a service is costly in terms of human labor, is prone to human error, and the quality of a deployment depends on the skills of the experts who perform these functions. Furthermore, the cost of using the experts to deploy a service may be encountered for each deployment instance of a service unless two instances are substantially similar in terms of their requirements, e.g. performance, security, availability, and their hardware platform and software. However, even a basic service deployment tends to change over time, resulting in increased design costs to accommodate changing service requirements.

### SUMMARY

A service configuration for a service is generated using a service specification and at least one library including at least one of a hardware component and a software component available to be implemented for the service.

### BRIEF DESCRIPTION OF THE DRAWINGS

The embodiments are illustrated by way of example and without limitation in the accompanying figures in which like numeral references refer to like elements, and wherein:

FIG. 1 shows a schematic diagram of a system for generating a service configuration, according to an embodiment;

FIGS. 2A-B show an example of a service specification, according to an embodiment;

FIGS. 3A-B, 4A-B, and 5A-B show examples of libraries that may be used to generate a service configuration, according to an embodiment;

FIG. 6 shows examples of compilation invocation to generate services according to an embodiment;

FIG. 7 shows a flow chart of a method for generating a service configuration, according to an embodiment;

FIG. 8 shows a flow chart of a method for generating a service configuration, according to another embodiment;

FIG. 9 shows a system for configuring a reconfigurable data center, according to an embodiment; and

FIG. 10 shows a reconfigurable data center, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

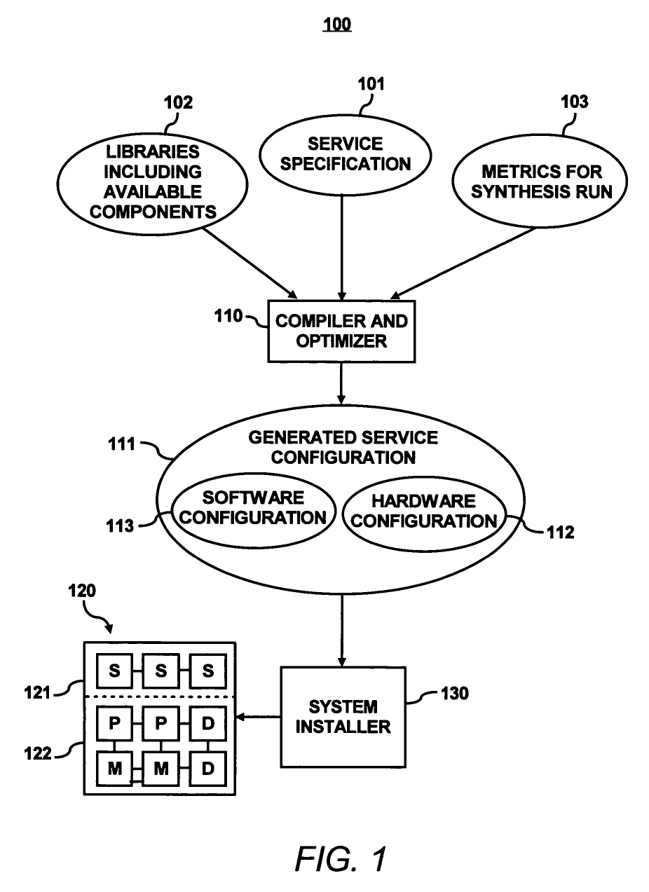

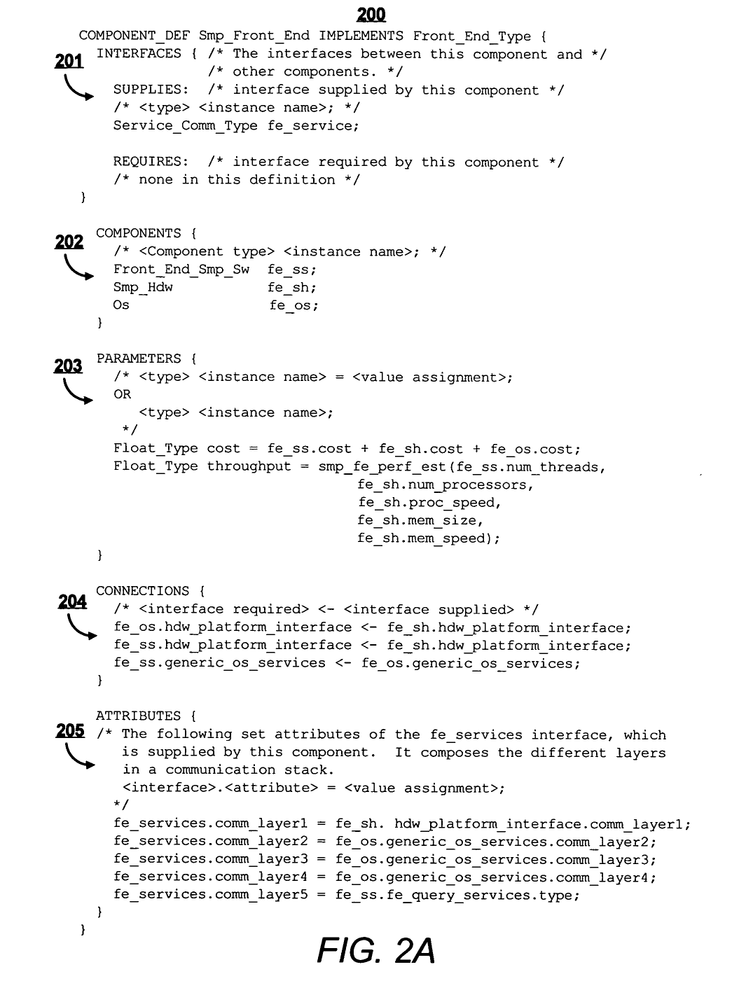

FIG. 1 illustrates a system 100 for compiling and synthesizing service configurations for a service, according to an embodiment. A service is a combination of hardware and software components that is functional to meet predetermined requirements. For large-scale services, this may include one or more servers and the software, e.g., an ensemble of programs, needed to implement the desired functionality. A service configuration is a description of the hardware and software components for the service and is used to deploy the service. The system 100 may also be used to synthesize a service configuration for a service component that can be used as a service or with other service components to provide a service. A service component is software, hardware, or a combination of hardware and software. The service component may comprise a portion of a service or may be used as a complete service. An example of a service may include an Internet retail service. Service components may include a webserver, operating system, billing software, database, etc.

The system 100 includes data comprising a service specification 101, libraries 102, and metrics 103. The service specification 101, the libraries 102, and the metrics 103 together make up the requirements and criteria for configuring a service 120. The service specification 101 and the libraries 102 are input into a compiler and optimizer 110. The compiler and optimizer 110 generates a service configuration 111 of the service or the service component. The system 100 may generate several possible service configurations for the service. That is several possible combinations of hardware and software may be available for providing the service. The compiler and optimizer 110 may optimize the service configurations by simulating and testing using the metrics 103, which may include metrics provided in the service specification 101 and the libraries 102, to select the service configuration that best meets the user needs for a service.

The compiler and optimizer 110 outputs the service configuration 111 to a system installer 130 which deploys the service 120, including hardware components 122 and software components 121. The service configuration 111 may include a software configuration 113 and a hardware configuration 112. The software configuration 113 includes a description of the software components, such as the software components 121, to be used in the deployed service 120, and the hardware configuration 112 includes a description of the hardware components, such as the hardware components 122, to be used in the deployed service 120. Examples of the hardware components may include processors, memory, disks, servers, etc., and examples of the software components may include software applications, operating system, BIOS, etc. and possibly the connections between the hardware components, between the software components and/or between the hardware and software components.

The system installer 130 deploys the service 120, which may include parsing the service configuration 111 to identify the hardware and software components to be used for the service, mapping the descriptions to actual hardware and software components, installing the software, connecting the hardware, etc. The system installer 130 and deploying a configuration into a hardware platform and software components is further described in U.S. Patent Application Serial Numbers TBD (Attorney Docket Nos. 200314982-1, 200314983-1, and 200314985-1) all of which are incorporate by reference in their entireties.

The system 100 may be used as an automated design tool for planning and designing a service. Decisions regarding which hardware or software components to use for a service are performed by the compiler and optimizer 110, rather than requiring a substantial amount of manual labor to perform the same process. The system 100 is operable to quickly adapt to evolving user requirements for a service at a reduced cost. Furthermore, by substantially automating the service design process using the system 100, human error is minimized.

The service specification 101 and the libraries 102 are descriptions of a service and the specific hardware and software components available for generating the service configuration 111, respectively. The service specification 101 is a high-level description of the service. The high-level description may be divided into a description of different components of the service. The high-level description in the service specification 101 is generally broad such that there may be several different hardware and software options for deploying the service. The libraries 102 may be hardware or software options that are available for deploying the service, and thus the libraries 102 may limit the number of configurations that may be used to provide the service. The available components in the libraries for deploying the service vary by customer or user, because different users or customers may have or require different components for the service. Returning to the example of an Internet retail service, the service specification 101 includes web server software. The libraries 101 may include a library that limits the operating system (OS) for the web server software to freeware. Thus, the compiler and optimizer 110 may select a freeware OS, such as Linux, rather than a proprietary OS. This may also effect the web server software selection performed by the compiler and optimizer 110. For example, the web server software selection may be limited to servers that can run on the selected freeware OS.

In summary of FIG. 1, the service specification 101, the metric 103, and available components to be used for a service provided in the libraries 102 are input into the compiler and optimizer 110. These inputs represent information that may originate from different sources, and may change or be reused across usage instances. The service specification 101 represents a high-level specification of a desired service. Thus, the same service specification 101 may be used many times for different customer installations with different available components for building the service and to meet different metrics, such as cost and performance. With the available components captured in the libraries 102, different customers using or considering using different building blocks will use different libraries 102. Conversely, component libraries 102 may be used for many different services. For example, an OS component, or a server hardware component is highly reusable for many different services. The metrics 103 captures constraints and goals such as cost and performance requirements. These may vary from one synthesis run to the next, even when both the service specification 101 and the libraries 102 are kept constant, as a user experiments with different design goals.

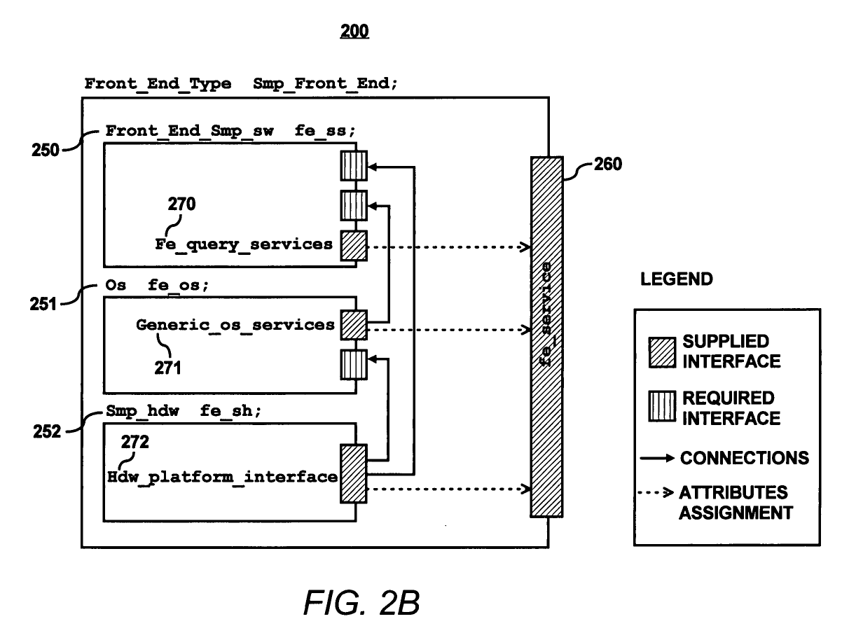

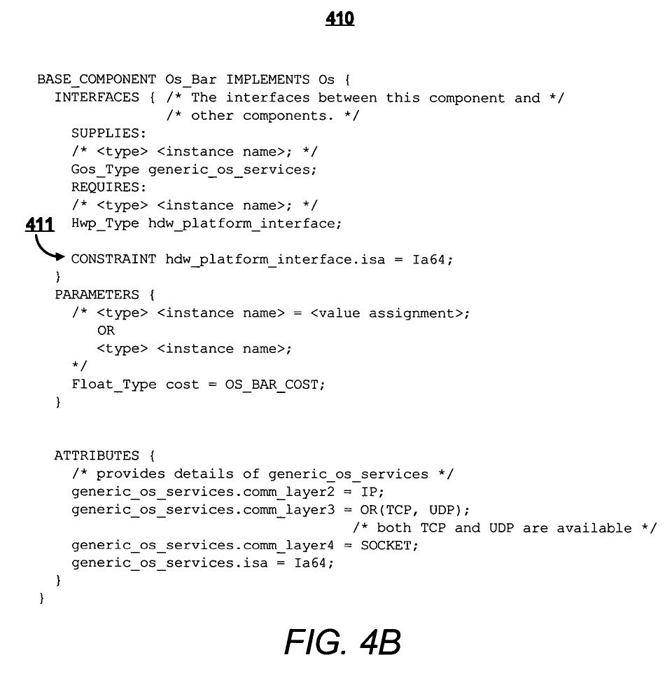

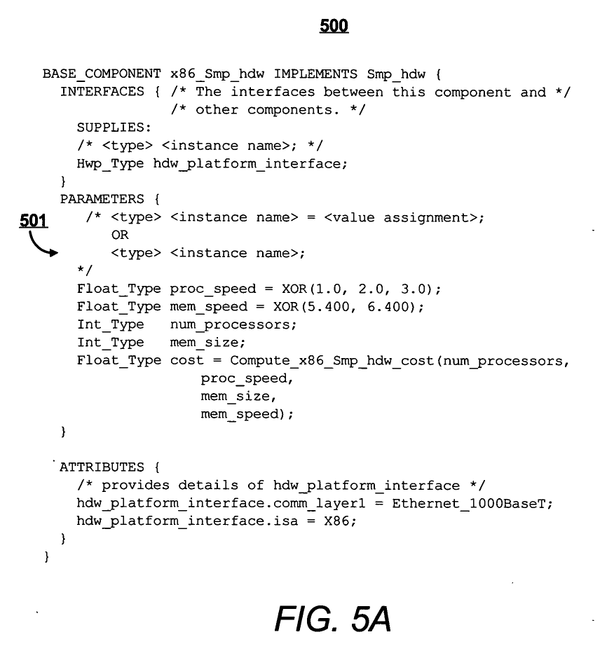

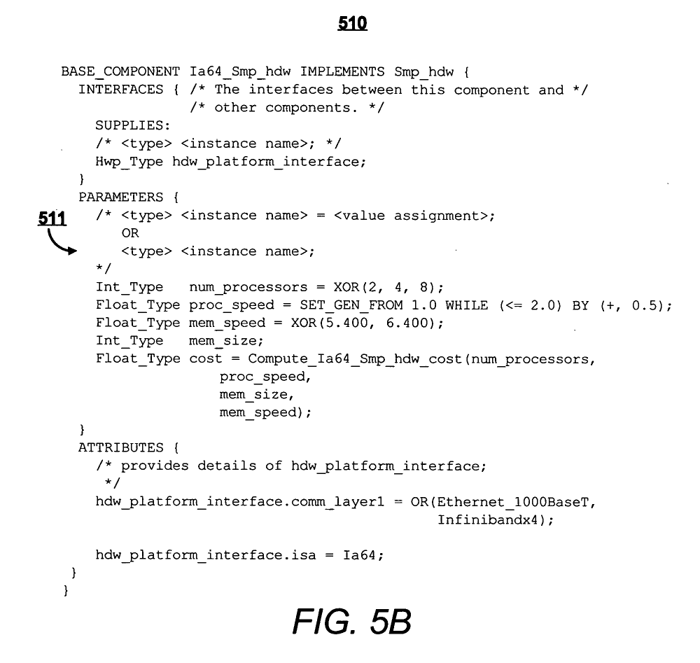

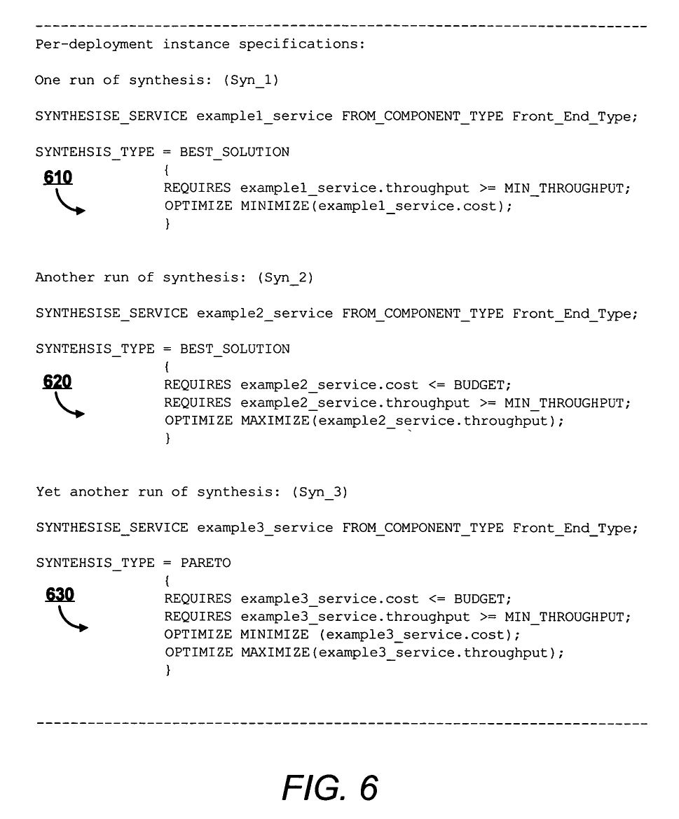

FIG. 2A shows an example 200 of a service component specification, which may be used as part of the service specification 101, and FIG. 6 shows how the service component specification may be invoked in several synthesis runs where the service component specification is synthesized into a service. A synthesis run is the processes performed by the compiler and optimizer 110 using the service specification 101, the libraries 102, and the metrics 103 to generate the service configuration 111 and to deploy the service 120.

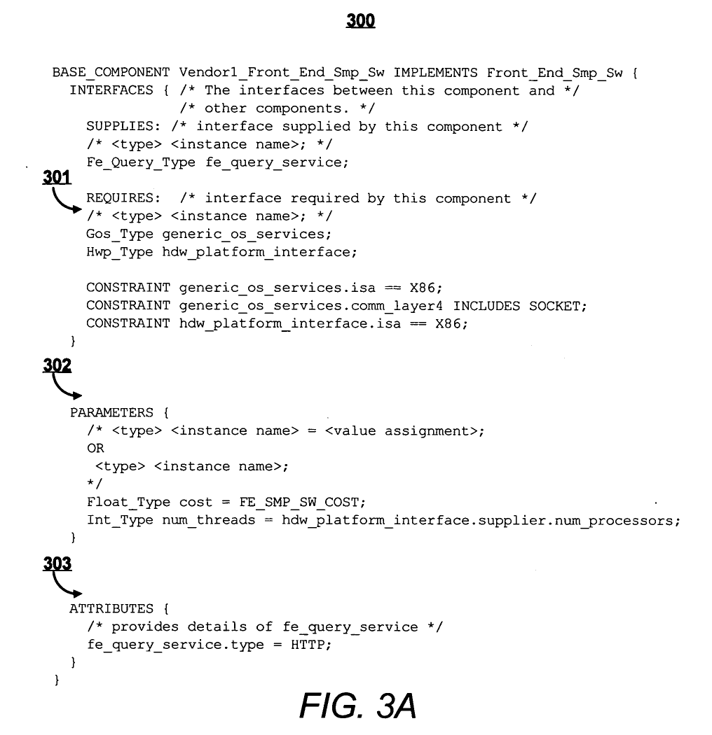

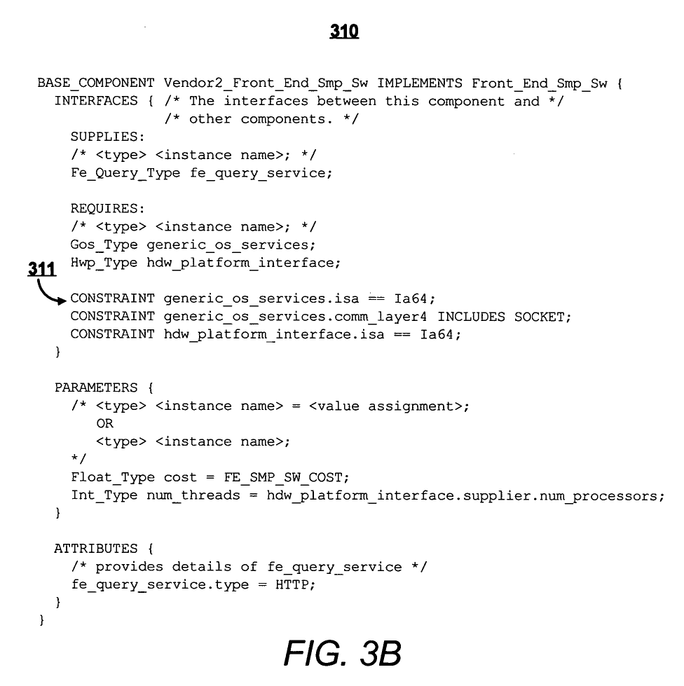

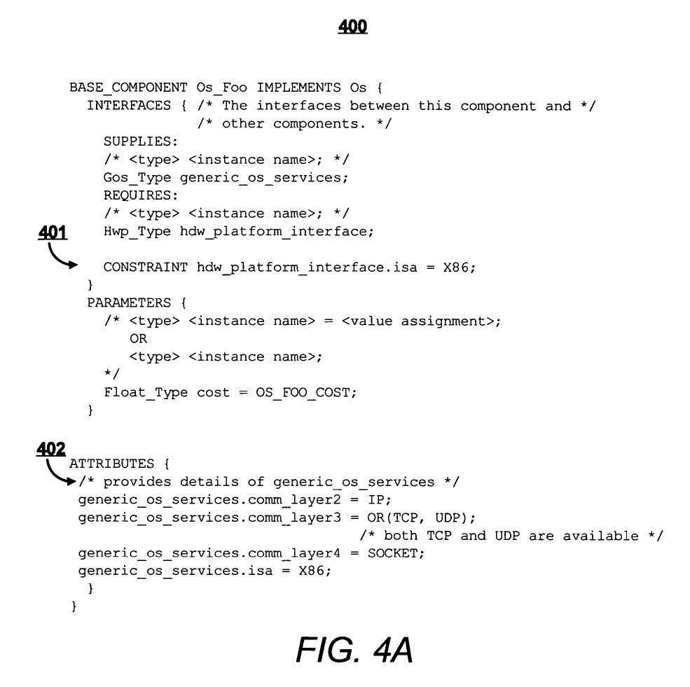

FIGS. 3A, 3B, 4A, 4B, 5A, and 5B show examples of the libraries 102, which may be used for each synthesis run. The libraries define the hardware and software available to be used to construct a service. The specification in the example 200 and the examples of libraries shown in FIGS. 3A, 3B, 4A, 4B, 5A, and 5B include components. The components may include base components or non-base component expressed in terms of other components. Note that a component may be software, hardware or combination of hardware and software.

The example 200 shown in FIG. 2A is a high-level description of a service component to be generated, such as the service 120 in FIG. 1. In the example 200, the specification uses concepts and syntax related to those of a high-level programming language, such as C++. It will be apparent to one of ordinary skill in the art that the high level description in a service specification can be provided in one of many forms and may be input into the compiler and optimizer 110 as a data structure or another type of input. FIG. 2B illustrates the example 200 of FIG. 2 in a graphical form.

The example 200 provides a description of a component called Smp_Front_End which implements the type Front_End_Type. Smp_Front_End may be synthesized into a service or be used as a service component that forms a portion of a complete service, such as the Internet retail service. During synthesis when an instance of Front_End_Type is needed, the compiler and optimizer 110 may substitute Front_End_Type with the definition of Smp_Front_End such as the one in FIG. 2A, in a manner similar to macro expansion or procedure inlining in traditional software compilation.

SMP_Front_End defines a front end function running on a symmetric multi-processor (SMP) hardware. A symmetric multi-processor is one type of hardware component for the service being deployed. Other component definitions implementing the Front_End_Type functionality may be defined with different hardware types. These may include clusters, which are multi-processor systems without shared memory, or a single processor system.

The component specification Smp_Front_End includes, by way of example, an interface specification 201, a components specification 202, a parameters specification 203, a connections specification 204, and an attributes specification 205. The interface specification 201 declares the interfaces between this component and other components when they are deployed in a service. It has two parts. The first part demarcated by the keyword “SUPPLIES” specifies the interfaces provided by this service. The Smp_Front_End supplies an interface called fe_service, of type Service_Comm_Type. The second part demarcated by the keyword “REQUIRES” describes the interfaces required by the service. In the example 200, there is no required interface.

The components specification 202 specifies the components needed to produce an instance of the Smp_Front_End service. These components used to produce another component are referred to as the latter's constituent components. In the example 200, three components are needed: a component of type Smp_Hdw, a component of type Os, and a component of type Front_End_Smp_Sw. The Smp_Hdw component provides the basic underlying hardware for the service. The instance of Smp_Hdw used in Smp_Front_End is referred to locally as fe_sh. The Os component provides operating system services. The instance of Os used in Smp_Front_End is referred to locally as fe_Os. The Front_End_Smp_Sw component provides the application logic of the front end. The instance of Front_End_Smp_Sw used in Smp_Front_End service is referred to locally as fe_ss.

The parameters specification 203 specifies parameters, which are used to convey information from the component definitions in the example 200, and metric information, such as the metrics 103 shown in FIG. 1, to the compiler and optimizer 110. The parameters can be referenced locally, but may also be referenced from other services or other service components. In the example 200, two parameters are specified. A first parameter is called cost of type Float_Type. The description of cost describes how cost is computed, such as by adding the cost parameters of the constituent components fs_ss (referenced by the notation fe_ss.cost), fs_sh (referenced by the notation fe_sh.cost), and fs_os (referenced by the notation fe_os.cost). A second parameter is called throughput. The description of throughput in the parameters specification 203 shows that throughput is computed using the parameters fe_ss.num_threads, fe_sh.num_processors, fe_sh.proc_speed, fe_sh.mem_size, and fe_sh.mem_speed. The actual method of computing throughput from these input parameters is specified in the function smp_fe_perf est. This function is produced by the designers of Smp_Front_End, and may be produced based on test runs, and/or analytical models.

The cost and throughput parameters are expressed in terms of constituent component's parameters (e.g., fe_ss.cost, fe_ss.num_threads, etc.). In the definition of the components used to instantiate the constituent component, these parameters may be expressed in terms of other parameters and so on. Parameters that are not expressed in terms of other parameters may be assigned a constant value or are search parameters. During synthesis, the compiler and optimizer 110 binds each search parameter to different values as it generates and simulates different candidate platform descriptions and corresponding configurations. Details of this process are described later. It will also be shown that during synthesis, known parameter values may be propagated to references, eventually allowing the top-level parameters to be computed. In many instances, the parameters specified in the parameters specification 203 relate directly to values that a particular designer considers important, e.g. cost has to be kept within a budget, throughput has to be kept above a certain minimum performance requirements, etc.

The connections specification 204 describes how the components described in the components specification 202 are connected by “hooking up” required and supplied interfaces. For example, the fe_sh component supplies an interface called hdw_platform_interface. The fe_os and the fe_ss components both hookup to the hdw_platform interface. The fe_os component supplies a generic_os_services interface, which the fe_ss component uses. These hookups are specified in the connections specification 204.

For example, fe_os.hdw_platform_interface<-fe_sh.hdw_platform_interface means the hdw_platform_interface supplied by the fe_sh component instance is hooked up to the fe_os's required interface hdw_platform_interface. The other two connection statements in FIG. 2:fe_ss.hdw_platform_interface<-fe_sh.hdw_platform_interface and fe_ss.generic_os_services<-fe_os.generic_os_services have similar meanings. FIG. 2B illustrates these connections with thin arrowed lines.

The attributes specification 205 specifies more information about the interfaces. In the example 200, the attributes specification 205 describes how the fe_service interface offered by the Smp_Front_End takes on attributes of the interfaces of its constituent components. For example, the fe_sh supplies the physical layer (layer1), e.g. Ethernet_{—}1000BaseT is used if a synthesized Smp_Front_End service uses the x86_Smp_hw library component defined in FIG. 5A. The fe_os supplies the next few communication layers, e.g. IP (layer2), TCP (layer3), and socket (layer3) layers if either Os_Foo or Os_Bar of FIGS. 4A and 4B are used in a synthesized service. The fe_ss provides the top level application interfaces for processing requests (layer 4). It is useful to encapsulate all of the information about the communication layers in this example into one interface because when deployed, all of these communication layers may be needed to provide the actual service.

FIG. 2B illustrates the component definition in the example 200 in graphical form. Three components 250-252 from the components specification 202 from FIG. 2A are shown in FIG. 2B. Smp_Front_End includes a supplied interface 260 defined in the definition of the example 200. The supplied interface 260 includes attributes, such as described in the attributes specification 205 shown in FIG. 2A. The example 200 also illustrates connections between components. For example, the interfaces 270 and 271 are both connected to the interface 272 as specified in the connections specification 204 of the example 200. Also, the interface 271 is connected to the interface 270 as specified in the connections specification 204. FIGS. 3A, 3B, 4A, 4B, 5A, and 5B show examples of the libraries 102, which may be specific to each synthesis run. FIGS. 3A and 3B illustrate libraries 300 and 310 respectively. The library 300 is a base component called Vendor1_Front_End_Smp_Sw which implements an instance of the component type Front_End_Smp_Sw. The general syntax and semantics of the library 300 and the libraries shown in the FIGS. 3B, 4A, 4B, 5A, and 5B is similar to the syntax and semantics of the example 200 shown in FIG. 2A. All are base components in that they do not comprise any other components.

The libraries 300 and 310 define base components implementing the Front_End_Smp_Sw type. The libraries 301 and 311 include constraints 301 and 311 respectively. The constraints 301 or 311 must be met during the synthesis performed by the compiler and optimizer 110 when generating possible configurations for simulation and possibly deployment if the libraries 300 or 310 are referenced by the service specification. For example, the constraints 301 limit configurations to X86 hardware platforms and an OS that runs on X86 hardware platforms. This may be because the Vendor1_Front_End_Smp_Sw only works on X86 platforms. Hence, the constraints 301 require that the hdw_platform_interface's “isa” (instruction set architecture) is X86 and similarly, that the “isa” of the component supplying generic_os_services is X86.

A further description of the constraints 301 is as follows, and the constraints 311 are similar. The first of the constraints 301 is CONSTRAINT generic_os_services.isa==X86; The expression generic_os_services.isa refers to the attribute isa on the interface supplied to fulfill the generic_os_services interface requirement. This depends on the context in which an instance of the Vendor1_Front_End_Smp_Sw is used. In the context of example 200 shown in FIG. 2, if an instance of Vendor1_Front_End_Smp_Sw is used as fe_ss, generic_os_services is supplied by fe_os, owing to the connections specified in example 200. The exact value of the isa attribute depends on the actual component used to build fe_os. For example, if during a synthesis run the compiler and optimizer 110 uses an instance of the x86_Smp_hdw defined in FIG. 4A, the value will be X86 and the constraint is satisfied. Had the compiler and optimizer 110 attempted to use an instance of the Ia64_Smp_hdw defined in FIG. 4B, the isa attribute value will be Ia64 and the constraint will not be satisfied. The latter case indicates an infeasible combination of Front_End_Smp_Sw and Smp_hdw components for constructing Smp_Front_End, which would be rejected by the compiler and optimizer 110.

Another constraint in 301 is CONSTRAINT generic_os_services.comm_layer4 INCLUDES SOCKET. The expression <x> INCLUDES <y> is true if <x> is a set and <y> is a member of that set. In this case, the constraint checks that the comm_layer4 attribute of the interface provided to fulfil the generic_os_services requirement of Vendor1_Front_End_Smp_Sw includes SOCKET. Again, this constraint is tested in the context in which an instance of Vendor1_Front_End_Smp_Sw is used. In the context of example 200, this interface is supplied by fe_os. Thus, this constraint tests whether the component used as fe_os supplies a generic_os_services interface whose attribute comm_layer4 includes SOCKET.

The above description of the example 200 and the libraries 300 and 310 illustrate how the combination of interface, connections between interfaces, attributes, and constraint expressions with references to interface attributes enables a component's definition to set conditions regarding the context in which the component is used. This is important for a component that can be re-used in many contexts, particularly as part of a library. Specifying the requirement as constraints rather as part of the component type enables composite components, such as in the example 200 of FIG. 2, to be very general. For example in the example 200, this generality enables the compiler and optimizer 110 to generate services that can either support X86 or Ia64 as the isa. Had the isa been made part of the component type, the component definition in the example 200 could not have been used to generate both types of services. Two definitions, each for a different isa, would have been needed to generate both types of services. As such diversity multiplies, a type-based only approach would lead to exponential increase in number of definitions.

The parameters definition 302 in FIG. 3A defines two parameters cost and num_threads with types Float_Type and Int_Type respectively. The cost parameter is set to a constant value FE_SMP_SW_COST, while the num_threads parameter is set to the num_processors parameter of the hardware platform supplying the hdw_platform_interface. The expression: hdw_platform_interface.supplier refers to the component supplying the interface hdw_platform_interface, while hdw_platform_interface.supplier.num_processors refers to the num_processors parameter of that component. This value is of course dependent on the context in which an instance of this component is used.

The library 300, including the definition of the base component Vendor1_Front_End_SmpSw, has an attribute specification 303, fe_query_service.type=HTTP. If the base component definition in the library 300 is used to supply fe_ss in the example 200 of FIG. 2A, then the attribute specification 208 in the example 200 causes the comm_layer5 attribute of the fe_services interface to take on the value HTTP. This is due to the specification in 205 shown in FIG. 2A comprising fe_services.comm_layer5=fe_ss.fe_query_services.type. The constraints 311 in the base component of the library 310 are similar to the constraints 301 in the library 300, except the constraints 311 require an Ia64 hardware platform, and the OS must support Ia64.

The libraries 400 and 410 include base component definitions implementing the type Os. These definitions comprise parts and syntax similar to the libraries 300 and 310. For instance, the definitions in the libraries 400 and 410 include constraints 401 and 411 on the context in which these Os definitions may be used as constituents of a particular service configuration. In particular, the library 400 shown in FIG. 4A includes the definition of the base component Os_Foo, which is an implementation of the Os that only works with X86 hardware platform, i.e. the component supplying the hdw_platform_interface has to have X86 as its isa attribute.

In the attributes section 402 of the library 400, the attribute for comm_layer3 on the generic_os_services interface includes TCP or UDP. The expression OR(<x1>, . . . , <xn>) specifies a set with members <x1>, . . . , <xn>. As explained earlier, this enables whatever component that hooks up to this interface to reference attributes of the interface to verify compatibility. The library 410 shown in FIG. 4B is similar to the library 400, except it describes an Os limited to the Ia64 hardware platform.

The libraries 500 and 510 are shown in FIGS. 5A and 5B. The library 500 includes the definition of the base component x86_Smp_hdw, which is an implementation of Smp_hdw type. This implementation supports the X86 isa, as specified in the isa attribute of the hdw_platform_interface supplied by this component. The parameters specification 501 of library 500 uses the expression XOR(1.0, 2.0, 3.0) as the value assigned to the parameter proc_speed. The parameter proc_speed is an example of a search parameter, and XOR(1.0, 2.0, 3.0) is a search set with 3 elements 1.0, 2.0 and 3.0, in this case reflecting the GHz speed of processors, for the search parameter. During synthesis, the compiler and optimizer 110 may use an instance of the library 500 with any of these three values assigned to the parameter proc_speed.

The parameters specification 501 also includes two parameters num_processors and mem_size that are not assigned any value. These are search parameters whose search sets will be supplied at synthesis run time. A more detailed description of search parameters is provided below with respect to the description of the compiler and optimizer 110.

The cost parameter in the parameters section 501 is assigned a value computed from other parameters in the parameters specification 501, namely num_processors, proc_speed, mem_size and mem_speed. The actual computation is abstracted away in this example, and is represented by the function Compute_x86_Smp_hdw_cost. In an actual deployment instance of a service, the cost can vary depending on the actual number of and speed of processors, etc.

The library 510 includes the definition of the base component Ia64_Smp_hdw, which is another implementation of Smp_hdw type. This implementation supports the Ia64 isa. The parameter specification 511 of library 510 uses the expression SET_GEN_FROM 1.0 WHILE (<=2.0) BY (+, 0.5). This is another way to specify a search set. The first element of the search set is 1.0. The potential next element is obtained by applying the “+” operator to the previous element and 0.5. This potential next element, which we refer to as p, is added to the search set if it passes the test (p<=2.0). Generation of additional elements stops once the test fails. In this case, the search set generated has elements 1.0, 1.5 and 2.0.

FIG. 6 shows examples 610, 620, and 630 of information provided to the compiler and optimizer 110 for synthesizing service configurations. These examples may be provided in scripts that are executed by the compiler and optimizer 110 to invoke the synthesis or generation of service configurations for a service. In the example 610, the compiler and optimizer 110 synthesize a service configuration named example1_service by instantiating an instance of component definition Front_End_Type. The compiler and optimizer 110 is instructed to find a best solution that meets the requirement that the synthesized example1_service's throughput parameter exceeds MIN_THROUGHPUT, a constant value. Also, for all the configurations that meet that requirement, the compiler and optimizer 110 selects the configuration which minimizes the service's cost parameter. Also provided to compiler and optimizer 110 are the service specification 200 shown in FIG. 2A and the libraries shown in FIGS. 3A, 3B, 4A, 4B, 5A, and 5B for synthesizing the service configurations.

The example 620 is similar to the example 610 except the configuration selection criteria are different. The example 620 specifies that throughput has to be greater than MIN_THROUGHPUT, cost has to be below BUDGET, another constant represented here symbolically. From among all the configurations satisfying these requirements, the compiler and optimizer 110 selects the configuration which maximizes throughput.

The example 630 is similar to the example 620. However, instead of requesting a single configuration, the example 630 requests that the compiler and optimizer 110 generates possibly multiple configurations. These configurations must meet throughput and cost requirements. From among the set of configurations that do meet the requirements, the compiler and optimizer 110 removes the configurations that are clearly inferior to another configuration in the set. For example, the compiler and optimizer 110 generates configurations, for example in the form of hardware and software descriptions, that meet both requirements specified in the example 630. If a first configuration has a higher cost than a second configuration and the first configuration has weaker performance than the second configuration, then the first configuration is removed based on the requirements shown in the example 630.

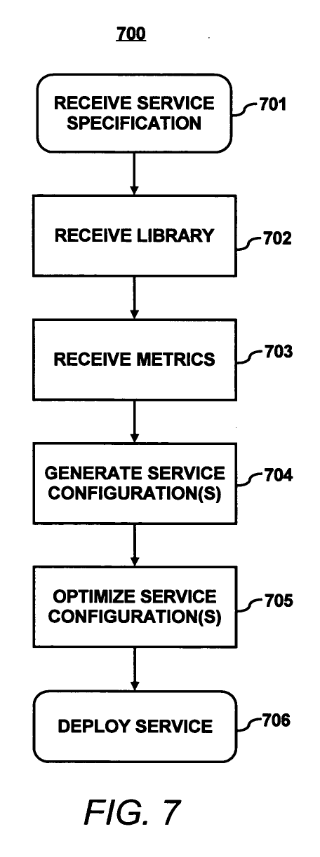

FIG. 7 illustrates a flow chart of a method 700 for generating one or more configurations based on a service specification, libraries and metrics, according to an embodiment. The method 700 is described with respect to the FIGS. 1-6 by way of example and not limitation. At step 701, the compiler and optimizer 110 receives a service specification, such as the service specification 101 shown in FIG. 1. The received service specification 101 may include a specification for a complete service or a component service specification such as the component service specification 200 shown in FIG. 2A. A service specification is typically provided in the format of a high-level computer language or other equivalent means such as in a visual, graphical form. The service is portable and thus may be used for different services and can be instantiated with different values by using different libraries and/or synthesis metrics. In addition, the service specification is a high-level description of a service, and the details regarding specific hardware components and software components used for the service may be provided through libraries. Furthermore, such details may vary from one configuration to another, depending on the library component chosen for each configuration.

At step 702, the compiler and optimizer 110 receives at least one library, e.g., at least one of the libraries 102 shown in FIG. 1, which may be referenced by the service specification 200 to provide details regarding hardware and software components for the service and constraints. Examples of libraries are shown in FIGS. 3A, 3B, 4A, 4B, 5A, and 5B. The libraries may be stored, and when referenced in a service specification, the libraries are utilized by the compiler and optimizer 110 to generate a service configuration.

At step 703, the compiler and optimizer 110 receives the metrics 103 shown in FIG. 1 for a synthesis run used to generate the service configuration 111. The compiler and optimizer 110 may optimize service configurations by simulating and testing using the metrics 103, which may include metrics provided in the service specification 101 and the libraries 102, to select the service configuration that best meets the user needs for a service. Examples of the metrics 103 may include cost, throughput, security, etc.

At step 704, the compiler and optimizer 110 generates at least one service configuration using the service specification 200, the library, and the metrics 103. Generating the service configuration may include compiling the service specification 200 and using libraries referenced by the service specification 200.

At step 705, the compiler and optimizer 110 optimizes the service configurations if a plurality of service configurations are generated. This may include selecting one service configuration, e.g., the service configuration 111 shown in FIG. 1, that best meets one or more of the metrics 103.

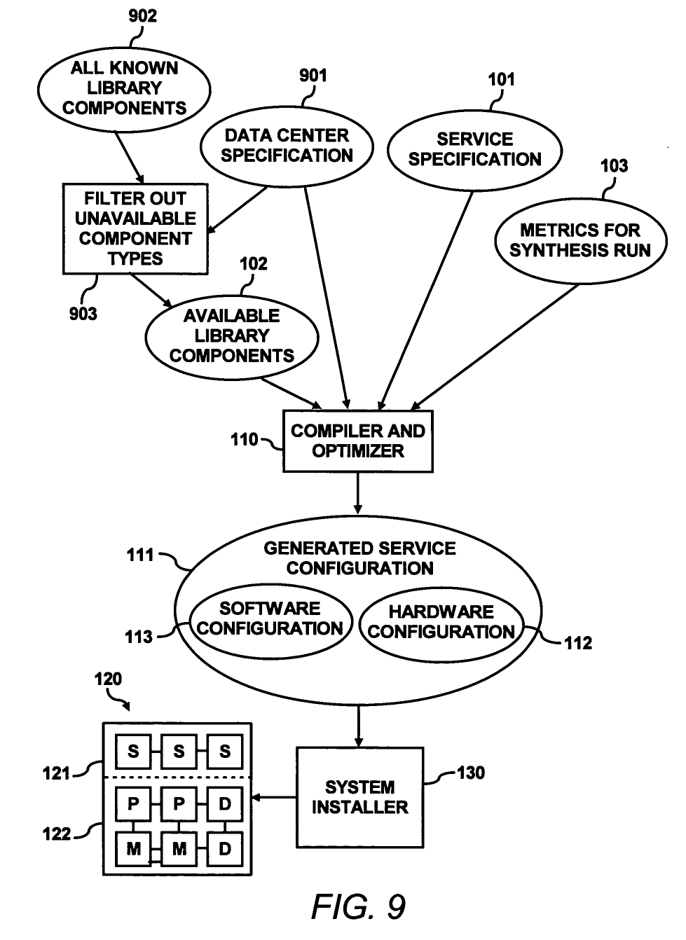

At step 706, the system installer 130 shown in FIGS. 1 and 9 deploys the service using the service configuration selected at step 704. The deployed service includes hardware and software components described in the service configuration 111 and referenced libraries.

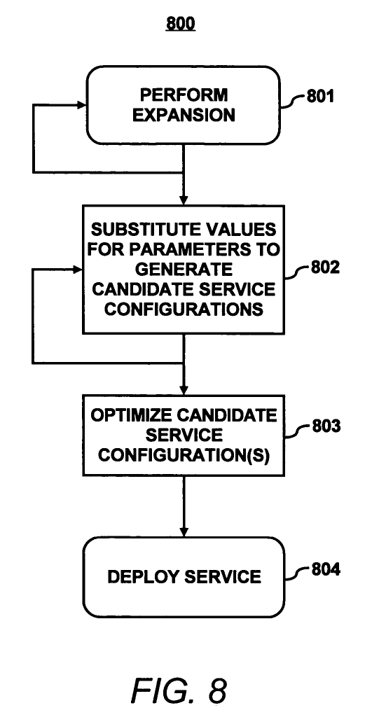

FIG. 8 illustrates a flow chart of a method 800 for generating one or more configurations based on a service specification and libraries, according to an embodiment. The method 800 includes substeps for the step 703 of generating at least one service configuration in the method 700. Specifically, steps 801 and 802 of the method 800 describe details for compiling a service specification to generate at least one service configuration. Steps 803 and 804 for optimizing and deploying a service configuration are substantially the same as the steps 704 and 705 of the method 700. Also, the method 700 is described with respect to the FIGS. 1-6 by way of example and not limitation.

At step 801, the compiler and optimizer 110 starts with the top-level component of the service specification 101 and substitutes constituent components with its component or base component definitions implementing the requisite types. This is called expansion, which is similar to procedure inlining or macro-expansion for software compilation. The compiler and optimizer 110 does this repeatedly until there are no more constituent components. When there are several possible substitutions for constituent components, the compiler and optimizer 110 generates a plurality of service configurations, one for each combination of components.

Examples of expansion performed at step 801 are as follows. Referring to example 610 in FIG. 6, the Front_End_Type is the desired service. In the service specification 200 shown in FIG. 2A, there is only one definition for Front_End_Type, which is Smp_Front_End. Next, there are three constituent components to substitute. These have types, as shown in FIG. 2A, Front_End_Smp_Sw, Os, and Smp_hdw.

There are two possible substitutions for Front_End_Smp_Sw. The definitions for the two possible substitutions for Front_End_Smp_Sw are provided in the libraries 300 and 310 shown in FIGS. 3A and 3B. There are also two possible substitutions for Os. The definitions for the two possible substitutions for Os are provided in the libraries 400 and 410 shown in FIGS. 3A and 3B. There are also two possible substitutions for Smp_hdw, which are provided in the libraries 500 and 510 shown in FIGS. 5A and 5B. This results in a total of 2×2×2=8 possible configurations before the compiler and optimizer 110 checks constraints.

The libraries also contain constraints. Every constraint has to be met, i.e. constraint specification statements evaluate to true for every candidate service configuration. Unmet constraints cause the compiler and optimizer 110 to prune a candidate service configuration, i.e., remove the configuration. The remaining candidate service configurations which meet the constraints are called valid candidate service configurations.

To generate valid candidate service configurations, the compiler and optimizer 110 checks constraints on the eight possible configurations for the example 610. The result of checking the constraints is two valid candidate service configurations. The two valid candidate service configurations are a combination of the definitions in FIGS. 3A, 4A and 5A (e.g., all related to the X86 isa) or 3B, 4B and 5B (e.g., all related to the Ia64 isa). The other configurations do not satisfy all constraints. For example, the combination of the definitions in FIGS. 3A, 4B and 5B results in the constraints 301 shown in FIG. 3A failing because in this composition context, Vendor1_Front_End_Smp_Sw requires both generic_os_services and hdw_platform_interface to have X86 isa attributes, while Os_Bar supplies a generic_os_services with Ia64 isa attribute, and Ia64_Smp_hdw supplies a hdw_platform_interface with Ia64 isa attribute.

Thus, there are only two valid candidate service configurations generated by the compiler and optimizer 110 at step 801. For ease of discussion, the first is referred to as the x86 valid candidate service configuration and the second is referred to as the Ia64 valid candidate service configuration.

At step 802, the compiler and optimizer 110 substitutes values for the parameters in the parameter specifications of the service specification and the libraries. There are base parameters and derived parameters. Derived parameters are defined based on one or more parameters. Base parameters are either bound to a constant, unbound, or bound to a search set. Base parameters bound to a search set are called search parameters. Derived parameters are directly or indirectly defined in terms of base parameters.

The parameters for cost and throughput provided in the parameter specification 203 shown in FIG. 2A are examples of derived parameters. Examples of base/search parameters include the cost parameters shown in FIGS. 3A and 3B, which are bound to constants. The parameters proc_speed and mem_speed shown in FIGS. 5A and 5B are bound to a search set, and the parameters num_processors and mem_size shown in FIG. 5A are unbound.

As described above, base parameters bound to a search set are called search parameters. A search set specifies a set of possible values for the search parameter. It may be expressed in several ways. The parameter proc_speed shown in FIG. 5A is bound to an enumerated search set. The syntax proc_speed=XOR(1.0, 2.0, 3.0) in the library 500 shown in FIG. 5A means the parameter proc_speed is bound to a search set with three members: 1.0, 2.0 and 3.0. Another way to describe a search set is shown in FIG. 5B: proc_speed=SET_GEN_FROM 1.0 WHILE (<=2.0) BY (+, 0.5). As described earlier, the compiler and optimizer 110 generates a search set with values 1.0, 1.5 and 2.0 for this expression.

Unbound parameters are converted to bounded parameters by the compiler and optimizer 110 to generate a service configuration. For example, for the unbound parameters the compiler and optimizer 110 prompts the user to provide search sets for the unbounded parameters, thus converting them to bounded parameters. In one embodiment, the compiler and optimizer 110 provides the user with valid candidate service configurations and a list of unbounded search parameters for each valid candidate service configuration. The user provides a search set for each unbounded search parameter. This effectively enables every search parameter to be bounded.

Thus, at step 802, the compiler and optimizer 110 may generate a plurality of valid candidate service configurations, and for each valid candidate service configuration, the compiler and optimizer 110 enumerates all possible combinations of search parameters. Each combination is called a fully bound candidate. Thus, a valid candidate service configuration, such as determined at step 801, may generate multiple fully bound candidates. For each fully bound candidate, i.e. each search parameter has been bound to a value, the compiler and optimizer 110 computes the value of all parameters.

Parameter values can also be subject to constraints. These constraints can either be specified within component/base-component definitions or supplied as requirements in a synthesis input (e.g. as shown in FIG. 6). Each fully bound candidate is tested to ensure that every constraint is met. Those that fail are removed. Those that survive are put into a set of feasible candidate service configurations. Self-loops are shown for steps 801 and 802 to illustrate that multiple service configurations may be generated at each of the steps.

At step 803, the compiler and optimizer 110 optimizes the set of candidate service configurations determined at step 802. This set includes the valid service configurations as determined at step 801 instantiated with the parameter values as determined at step 802. At step 803, optimization of the set includes comparing the set of feasible candidate service configurations to each other based on one or more metrics to identify the best service configuration from the set. FIG. 6 shows examples 610, 620, and 630 of information provided when the compiler and optimizer 110 synthesizes service configurations. Each example include different metrics for optimization. In the example 610 (Syn_1), the set of service configurations are optimized for cost, and the compiler and optimizer 110 selects the service configuration with the lowest cost. In the examples 620 and 630, the compiler and optimizer 110 optimizes for highest throughput or lowest cost and highest throughput. These examples also include constraints that may limit the set of feasible candidate service configurations. For example, the example 610 requires the feasible candidate service configurations to have a (throughput >=MIN_THROUGHPUT). The candidate service configurations that have a (throughput >=MIN_THROUGHPUT) are optimized for cost.

A Pareto curve may also be used for the goal of optimization. A Pareto curve is calculated by the compiler and optimizer 110 and only the feasible candidate service configurations on the Pareto curve are retained (i.e. clearly inferior service configurations, e.g. lower performance and higher cost than another) are removed from the set of feasible candidate service configurations. One of the remaining feasible candidate service configurations on the Pareto curve may be selected by the user for deployment.

At step 804, the system installer 130 of FIG. 1 and also shown in FIG. 9 deploys a service using one of the candidate service configurations selected as a result of the optimization. Deploying the service may include mapping hardware and software components to the descriptions in the selected service configuration, such as described in the aforementioned patent application TBD (Attorney Docket No. 200314982-1). The service 120 shown in FIG. 1 is an example of a deployed configuration. Before being deployed, i.e., implemented as actual software and hardware constituting the service, the configuration may be in the form of a description, such as the service configuration 111.

The steps for the methods 700 and 800 may be contained as a utility, program, and/or subprogram, in any desired computer accessible medium. The steps may exist as software instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

One of ordinary skill in the art would readily recognize that the component specification language and the service synthesis technique described above can be used to capture all sorts of constraints and requirements. In addition to cost and throughput, parameters may be defined to capture properties such as reliability, availability, security, etc. The reliability of a component, for example, can easily be expressed as a mathematical function of the reliability of its constituent components. The exact function may depend on the way these constituents are combined to produce the component.

High-level service specification, such as through the component specification method described above, and service synthesis using methods 700 and 800 are applicable to deploying services in a reconfigurable data center. A reconfigurable data center is described in detail below and in the aforementioned patent applications incorporated by reference above.

A reconfigurable data center comprises a collection of hardware components, including processors, memories, disks, I/O devices, other devices, and an interconnection network that is programmable and facilitates flexibly interconnecting the components to accommodate different configurations. The components may be configured and reconfigured to meet varying user requirements. For example, a reconfiguration system may pair a processor with a suitable amount of memory, such as an appropriate amount of memory to support an application or multiple applications, to form a computer system, referred to as a physical platform. In this example, the paired processor and memory work together to meet the needs of the applications that the processor runs. Physical memory not needed for this physical platform is assigned to another physical platform. These physical platforms may then be reconfigured, for example, to meet new user requirements. A physical platform may also include multi-processor systems with shared memory, and physical platforms may include other types of components such as disks, I/O devices, cooling resources, network switches, etc.

In the reconfigurable data center, reconfiguration is done programmatically, avoiding physical movement of hardware. This provides several benefits, including the ability to quickly configure the components to accommodate changing user requirements without manually moving system boards or re-cabling. Programmatic reconfiguration uses user requirements, referred to as logical platform specifications or a service specification (e.g., the service specification 101 shown in FIG. 9, and a data center specification (e.g., the data center specification 901 shown in FIG. 9) to select the components used for physical platforms during configuration. Also, a flexible interconnection network is provided that supports reconfiguring the components into different physical platforms. The interconnection network supports varying types of communication traffic including memory accesses, disk accesses, and other network traffic, and switches in the interconnection network may be programmed to accommodate reconfiguration of physical platforms.

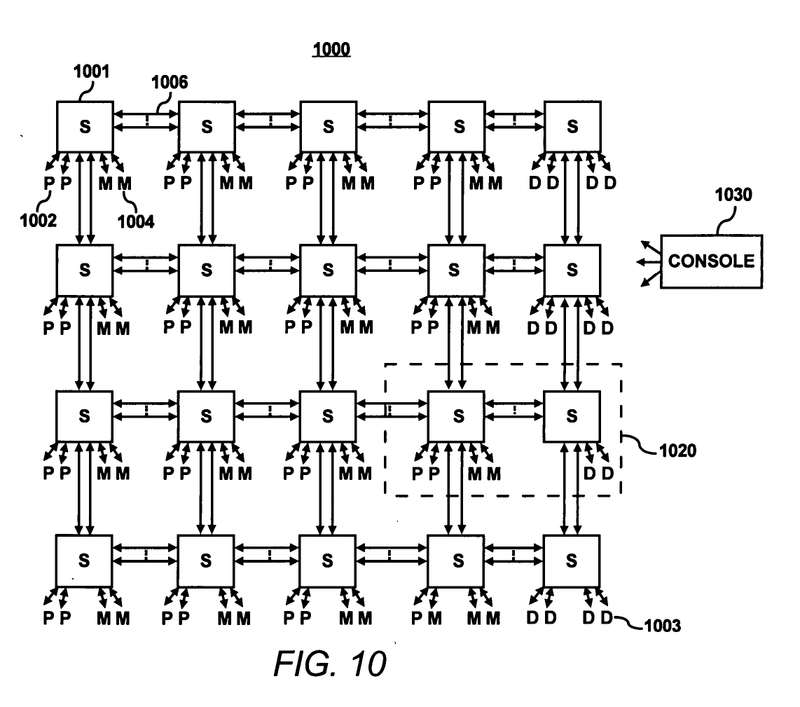

FIG. 9 illustrates a system 900 for configuring a reconfigurable data center. The system 900 is operable to configure the reconfigurable data center to provide a service. FIG. 9 is substantially the same as FIG. 1, except FIG. 9 includes a data center specification 901. The data center specification 901 includes a description of the components, such as a list of the components, in the reconfigurable data center. The data center specification 901 may include information about each component, such as component type, performance specifications, current load on a component, physical location of a component, etc. An example of the reconfigurable data center is shown in FIG. 10. The data center specification 901 may be used to describe all the components within the reconfigurable data center. The list in the data center specification 901 may include a description of the components, such as a description of the processors, memory modules, disks, I/O devices, and configurable switches in an interconnection network for the reconfigurable data center. An interconnection network as well as addressing in the reconfigurable data center and programming components in the reconfigurable data center to accommodate reconfiguration are described in the aforementioned patent applications.

Instead of including a list of all the components in the reconfigurable data center, in another embodiment the data center specification 901 describes only the components 102 that are available to be deployed as a physical platform. For example, some components may be committed to prior uses and thus are unavailable, or some components may be malfunctioning and thus are unavailable. A data center specification that only includes available components may reduce testing and configuring process times when generating service configurations and deploying a service.

An example of a description in the data center specification 901 may include a description of processor type and processor speed. Memory and disks may also be characterized by size and speed (e.g. rotational speed and seek time). Other components described in the data center specification 113 may include I/O or graphics display hardware. The description of the components may include a number of ports that are used to connect the components into a larger system in order to support communication between the components.

Within the reconfigurable data center, the components are connected with a network of links and switch units that provide communication, i.e., components in an interconnection network. Connected and coupled as used herein refers to components or devices being in electrical communication. The electrical communication may be via one or more other components or may simply be between the components sending and receiving information. The data center specification 901 may also include a description of the number and type of switches and switch ports that can be used for a physical platform. Network connections may be described in the data center specification 901 through a description of links. A link may connect a component to a switch object, a switch to a switch, or a component to another component. Non-point-to-point physical networks, such as broadcast networks that connect a single output port to many input ports, may also be described in the data center specification 901 if a non-point-to-point physical network is provided in the reconfigurable data center.

A shown in FIG. 9, a set of all known library components 902 is an input in system 900. This may be a superset of the component types available to synthesize a service. The data center specification 901 is used in conjunction with a filtering step 903, which may be performed by the compiler and optimizer 110 to remove the unavailable component types. The remaining library components form the available library components 102. Furthermore, parameter search sets and/or constraints may be generated in order to avoid generating configurations that require more instances of a component than are available in the reconfigurable data center for deploying the service. These parameters are combined with other metrics 103 provided in the synthesis run invocation command, e.g., the scripts shown in FIG. 6, to form the aggregated metrics 904. The compiler and optimizer 110 receives the service specification 101, the available component libraries 102, and the aggregated metrics 904. The service specification 101 is a high-level description of the service to be provided and the available libraries 102 provide details regarding the specific hardware and software components that may be used to provide the service 120. The aggregated metrics 904 are used to generate and optimize the service configuration.

The compiler and optimizer 110 generates the service configuration 111 based on the service specification 101, the available component libraries 102, and the aggregated metrics 904. The service configuration 111 includes a hardware configuration 112 and a software configuration 113. The hardware configuration 112 is a specification of the hardware platform, such as the x86_Smp_hdw 500 with all parameters bound, possibly to values chosen by the compiler and optimizer 110. So for instance, the number of processors and amount of memory is known.

The hardware configuration 112 is used by the system installer 130 to deploy the hardware platform for the service. This may including using the techniques described in the aforementioned patent application TBD (Attorney Docket No. 200314984-1), incorporated by reference above, which select the actual instances of reconfigurable data center components, also referred to as resource, for configuring the desired hardware platform. It may also utilize the techniques described in the aforementioned patent application TBD (Attorney Docket No. 200314982-1), incorporated by reference above, to install both the hardware and software of the generated service configuration 111.

The system installer deploys the service 120 based on a description of the hardware and software specified in the service configuration 111. The hardware and software are components that are available for use in the reconfigurable data center. Thus, these components are configured to provide the service. The service 120 includes a configured system within the reconfigurable data center that accommodates the requirements of the service. The service 120 includes both hardware and software components and interconnections. The interconnections include switches and wiring which connect components within the reconfigurable data center. The components are programmed to provide the service, and programming the components is described in detail in the aforementioned patent application TBD (Attorney Docket No. 200314983-1), incorporated by reference above. For example, the compiler and optimizer 110 may program processors, memory, interconnection network, and the like based on a particular configuration. Programming may include populating tables in the devices that are used for addressing, such as addressing between the processor and the memory, and for routing in the interconnection network. The tables are populated differently for each configuration.

FIG. 10 shows a schematic diagram of a reconfigurable data center 1000 including the components providing the service 120 from FIG. 1. The hardware components of the reconfigurable data center 1000 may include network switches 1001, processors 1002, memory 1004, disks 1003 and possibly other types of devices. The network of switches 1001 are interconnected with links 1006, for example, including copper wire or optical fiber to support communication between the switches 202 and the other components. The switches 1001 and the links 1006 are part of an interconnection network facilitating communication between the components in a physical platform. The switches 1001 are also connected to the processors 1002, memory 1004, and disks 1003. The switches 1001 can be programmed to facilitate communication among particular components. The links 1006 may include bi-directional data communication links forming part of an interconnection network connecting components in the reconfigurable data center 1000. The interconnection network is also configurable to accommodate new configurations of the components. A bi-directional data communication link is connected to a port that provides mirroring in-bound and out-bound sub-ports that connect, through the bi-directional link, to corresponding out-bound and in-bound sub-ports on another port. An interconnection network based on unidirectional links may also be employed to construct the reconfigurable data center 1000. The console 1030 may include the optimizer and compiler 110 and/or the system installer 130. The console 1030 may be connected to the reconfigurable data center 1000 through the interconnection network.

As described above, the service configuring system 900 deploys the service 120 using the components of the reconfigurable data center. The hardware components for the service 120 are shown in the dashed box 1020 and were selected by and configured by the system 900 based on the generated service configuration 111. The system 900 may also install the software components on the hardware components for the service. The components in the dashed box 1020 may be reconfigured and used for other services.

What has been described and illustrated herein are the embodiments along with some of its variations. The terms, descriptions and figures used herein are set forth by way of illustration only and are not meant as limitations. Those skilled in the art will recognize that many variations are possible within the spirit and scope of the embodiments, which intended to be defined by the following claims and their equivalents in which all terms are meant in their broadest reasonable sense unless otherwise indicated.

What is claimed is:

1. A method of generating a service configuration, the method comprising:
receiving a service specification for a service;
receiving at least one library including at least one of a hardware component and a software component available to be implemented for the service; and
generating at least one service configuration based on the service specification and the at least one library.

2. The method of claim 1, wherein receiving a service specification comprises receiving a high-level description of a service.

3. The method of claim 2, wherein receiving a high-level description of a service further comprises receiving the high-level description of the service wherein details regarding specific hardware components and software components to be used to provide the service are not included.

4. The method of claim 2, wherein receiving a high-level description of a service further comprises receiving the high-level description of the service wherein multiple service configurations are operable to be generated to provide the service based on the high-level description of the service.

5. The method of claim 2, wherein receiving a high-level description of a service further comprises receiving the high-level description of the service in a format of a high-level computer language.

6. The method of claim 1, wherein receiving at least one library further comprises receiving the at least one library, wherein the at least one library comprises constraints on a service configuration used to provide the service.

7. The method of claim 1, wherein receiving at least one library further comprises receiving the at least one library in a format of a high-level computer language.

8. The method of claim 1, wherein generating at least one service configuration further comprises compiling the service description to generate the service configuration.

9. The method of claim 8, wherein compiling the service description further comprises using at least one of a hardware description and a software description from the at least one library to compile the service description.

10. The method of claim 9, wherein the service configuration is a description of hardware and software components to be used in the service.

11. The method of claim 1, wherein generating at least one service configuration comprises generating a plurality of service configurations based on the service specification and the at least one library.

12. The method of claim 11, further comprising selecting one of the plurality of service configurations based on at least one metric.

13. The method of claim 12, further comprising deploying the service using the selected service configuration.

14. A method of generating a service configuration, the method comprising:
receiving a service specification;
receiving at least one library associated with generating a service configuration;
compiling the service specification using the at least one library;
generating at least one service configuration based on the compiled service specification.

15. The method of claim 14, wherein compiling the service specification further comprises:
determining whether any constituent components are provided in the service specification;
substituting the constituent components with respective definitions provided in one of the service specification and the at least one library.

16. The method of claim 15, wherein substituting the constituent components further comprises:
determining whether one of a plurality of substitutions are operable to be substituted for a constituent component;
selecting at least one of the plurality of substitutions based on at least one constraint in the at least one library.

17. The method of claim 14, wherein compiling the service specification further comprises:
identifying at least one parameter in the service specification; and
substituting at least one value for the at least one parameter based on a parameter specification for the at least one parameter.

18. The method of claim 17, wherein substituting at least one value for the at least one parameter further comprises:
determining whether the at least one parameter is bounded or unbounded;
requesting at least one value from a user if the at least one parameter is unbounded; and
substituting the at least one value from the user for the at least one parameter.

19. The method of claim 17, further comprising:
determining whether a plurality of values are operable to be substituted for the at least one parameter; and
generating at least one service configuration further comprises generating a service configuration for each of the plurality of values.

20. The method of claim 14, wherein generating at least one service configuration further comprises:
generating a plurality of service configurations based on the compiled service specification; and
selecting one of the plurality of service configurations based on at least one metric; and
deploying hardware and software based on the selected service configuration to provide a service.

21. The method of claim 14, wherein the service specification is portable.

22. The method of claim 21, further comprising:
substituting constituent components in the service specification with different library components associated with the constituent components to provide portability.

23. The method of claim 21, further comprising:
instantiating parameters in the service specification with different values to provide portability.

24. The method of claim 14, further comprising reusing the library.

25. The method of claim 24, wherein reusing the library further comprises:
identifying at least one constraint in the library; and
meeting the at least one constraint specified in library.

26. A computer readable medium on which is embedded one or more computer programs, said one or more computer programs implementing a method comprising:
receiving a service specification for a service;
receiving at least one library including at least one hardware component and at least one software component available to be implemented for the service; and
generating at least one service configuration based on the service specification and the at least one library.

27. The computer readable medium of claim 26, wherein generating at least one service configuration further comprises:
compiling the service specification using the at least one library to generate the at least one service configuration.

28. The computer readable medium of claim 27, wherein compiling the service specification further comprises:
determining whether any constituent components are provided in the service specification; and
substituting the constituent components with respective definitions provided in one of the service specification and the at least one library.

29. The computer readable medium of claim 27, wherein compiling the service specification further comprises:
identifying at least one parameter in the service specification; and
substituting at least one value for the at least one parameter based on a parameter specification for the at least one parameter.

30. An apparatus comprising:
means for receiving a service specification for a service;
means for receiving at least one library including at least one hardware component and at least one software component available to be implemented for the service; and
means for compiling the at least one service configuration using the at least one library to generate a service configuration for a service.

31. The apparatus of claim 30, wherein the means for compiling generates a plurality of service configurations for the service and the apparatus further comprises means for optimizing the plurality of service configurations to select one of the plurality of service configurations based on at least one metric.

32. The apparatus of claim 31, further comprising means for deploying the one of the plurality of service configurations to provide the service.

33. A reconfigurable data center comprising:
a plurality of components; and
a configuration system operable to receive a service specification for a service and compile the service specification to generate at least one service configuration including at least some of the plurality of components.

34. The reconfigurable data center of claim 33, wherein the plurality of components comprise hardware components and software components.

35. The reconfigurable data center of claim 34, wherein the configuration system is further operable to deploy a service including at least some of the hardware components and the software components configured to conform to the at least one service configuration.

36. The reconfigurable data center of claim 33, wherein the configuration system is further operable to compile the service specification using at least one library including constraints on at least one of hardware components and software components that are available for use in the deployed service.
